(19) United States
(12) Patent Application Publication
(10) Pub. No.: US 2026/0051174 A1
(43) Pub. Date: Feb. 19, 2026

(54) METHOD FOR DISPLAYING OBJECT OF INTEREST IN CCTV MONITORING SYSTEM, AND CCTV MONITORING SYSTEM AND RECORDING MEDIUM THEREOF

(71) Applicant: KOREA INSTITUTE OF SCIENCE AND TECHNOLOGY, Seoul (KR)

(72) Inventors: Ig Jae KIM, Seoul (KR); Haksub KIM, Seoul (KR); Gi Pyo NAM, Seoul (KR); Haesol PARK, Seoul (KR); Yonghun CHOI, Seoul (KR)

(73) Assignee: KOREA INSTITUTE OF SCIENCE AND TECHNOLOGY, Seoul (KR)

(21) Appl. No.: 19/302,663

(22) Filed: Aug. 18, 2025

(30) Foreign Application Priority Data
Aug. 19, 2024 (KR) 10-2024-0110604

(51) Int. Cl. G06V 20/52; H04N 7/18

(52) U.S. Cl. CPC G06V 20/52; H04N 7/181

(57) ABSTRACT

According to an embodiment, there is provided a method for displaying an object of interest in a CCTV monitoring system, including a first operation of receiving, by the CCTV monitoring system, an object of interest to be searched, a second operation of acquiring, by the CCTV monitoring system, a plurality of tubes related to the object of interest from each camera of the CCTV monitoring system and providing the tubes through a first user interface, and a third operation of identifying, by the CCTV monitoring system, a search target based on a tube selected through the first user interface and generating and displaying a path based on the order in which the identified search target appears in each camera of the CCTV monitoring system, wherein, in the second operation, the plurality of tubes are displayed in order of highest to lowest similarity to the object of interest.

### CROSS REFERENCE TO RELATED APPLICATION

The present application claims priority to Korean Patent Application No. 10-2024-0110604, filed on Aug. 19, 2024, the entire contents of which is incorporated herein for all purposes by this reference.

### BACKGROUND OF THE INVENTION

### Field of the Invention

The present disclosure relates to a technology of effectively tracking, analyzing, and visualizing a path of an object of interest in an intelligent monitoring system using a plurality of CCTV cameras.

### Description of the Related Art

A CCTV monitoring system is an integrated security solution that monitors and stores videos collected from a plurality of CCTV cameras in real time on a central server, allows monitoring agents to analyze these videos to identify, track, and trace paths of specific individuals, enabling efficient surveillance and rapid response.

This CCTV monitoring system typically includes a plurality of CCTV cameras, a video storage and processing server, a monitoring station, analysis software, etc.

The conventional technology related to the present disclosure includes various methods for tracking paths of pedestrians in the CCTV monitoring system. These methods can be generally classified into a single-CCTV-based tracking system, a facial recognition-based tracking system, a GPS-based position tracking system, a passive CCTV monitoring system, and a simple object tracking algorithm-based system.

The single-CCTV-based tracking system tracks a path of a specific object using a computer vision algorithm within a single CCTV video. This method is effectively performed within a limited area, but has limitations in continuous tracking over a wide area.

The facial recognition-based tracking system identifies and tracks a face of a specific person from a plurality of CCTV cameras. This technology requires a high-resolution camera and a high-performance facial recognition algorithm and is effective in situations in which a target's face is clearly visible.

The GPS-based position tracking system tracks positions through GPS devices, making it useful for wide-area outdoor tracking. However, it is difficult for this method to be directly connected with a CCTV system, and the method has a disadvantage of being less accurate indoors or in areas with weak GPS signals.

The passive CCTV monitoring system enables control personnel to monitor a plurality of CCTV screens at the same time and manually track targets. This method relies heavily on human resources and is prone to errors due to fatigue during long-term monitoring.

The simple object tracking algorithm-based system extracts features of objects and tracks objects based on these features using a computer vision technology. This method enables automated tracking, but has problems such as reduced accuracy in complex environments, cumulative errors during long-term tracking, etc.

These conventional technologies each have their own advantages and disadvantages, but have limitations in terms of accurate and efficient path tracking over large areas, seamless object switching between a plurality of CCTV cameras, privacy protection, stable tracking in complex environments, etc. In particular, it is difficult to integrate information from the plurality of CCTV cameras to track a continuous and accurate path, and finding an appropriate balance between automated and human-based systems remains a challenge.

In addition, the lack of effective visualization and analysis capabilities for tracking results limits the effective use of tracked information in actual monitoring tasks.

### SUMMARY OF THE INVENTION

The present disclosure is directed to continuously tracking pedestrians between a plurality of CCTVs, accurately identifying pedestrians in complex environments, efficiently estimating a path including blind spots between the CCTVs, providing a monitoring operator-friendly interface for intuitive understanding and manipulation of complex tracking information, effective integrating and analyzing various CCTV video data, and maintaining a balance between privacy protection and effective tracking.

According to an embodiment, there is provided a method for displaying an object of interest in a CCTV monitoring system, including a first operation of receiving, by the CCTV monitoring system, an object of interest to be searched, a second operation of acquiring, by the CCTV monitoring system, a plurality of tubes related to the object of interest from each camera of the CCTV monitoring system and providing the tubes through a first user interface, and a third operation of identifying, by the CCTV monitoring system, a search target based on a tube selected through the first user interface and generating and displaying a path based on the order in which the identified search target appears in each camera of the CCTV monitoring system, wherein, in the second operation, the plurality of tubes are displayed in order of highest to lowest similarity to the object of interest.

In the first operation, characteristics of the object of interest to be searched may be received as text, or a time and position of the last sighting of the object of interest may be further received.

In the second operation, the plurality of tubes may be classified and displayed by CCTV.

The first user interface may include an area that displays the object of interest to be searched, an area that displays tubes searched from a plurality of CCTVs, and an area that displays similarity between the object of interest to be searched and the searched tube.

The first user interface may further include a similarity display box that is color-coded according to the similarity between the corresponding tube and the object of interest to be searched.

The third operation may include an operation (a) of searching for a search target in adjacent CCTVs based on an initial position of the identified search target in consideration of an estimated moving speed and direction of the search target, an operation (b) of sorting the searched search targets in chronological order, an operation (c) of determining whether the search target is likely to move between detection points of the search target based on a time interval and spatial distance between the detection points, and an operation (d) of connecting the detection points based on the determination to generate a preliminary path.

The preliminary path may be displayed in chronological order along with at least one of a CCTV video thumbnail, position information, and time information.

When the path is confirmed by selection of a monitoring operator after the operation (d), the third operation may include configuring and displaying a second user interface including a CCTV area that displays search results from the corresponding CCTV, a map area that displays the path on a map, and an area that displays path tracking results along a timeline.

In the second user interface, a section that it is determined that the CCTV monitoring system is uncertain may be distinguished and displayed with a special color or pattern in the timeline and map view.

In the map area, the path may be displayed by connecting positions according to the CCTVs in which the search target appears, the position of the search target may be mapped to a 2D map and displayed as an icon on the 2D map, and when the icon is selected, a CCTV video at the corresponding position may be displayed.

According to the present disclosure, by integrally processing the plurality of CCTV videos, interest objects (e.g., pedestrians) across a wide area can be continuously tracked, and particularly, the accuracy of path estimation can be increased by comparing and analyzing temporal and spatial limitations between the CCTVs.

In addition, according to the present disclosure, by visualizing complex tracking results through the intuitive user interface displaying paths, the CCTV monitoring system can assist the understanding and decision-making of the monitoring operator operating the CCTV monitoring system, and by combining the automated path estimation function with the manual control function, the accuracy and flexibility of the tracking can be enhanced.

In addition, according to the present disclosure, impossible paths can be automatically detected and alerted during path estimation, thereby minimizing tracking errors.

### BRIEF DESCRIPTION OF THE DRAWINGS

FIG. 1 is a view showing a configuration of a CCTV monitoring system that implements a representative patch selection method of an object of interest according to an embodiment.

FIG. 2 is a view showing a flow of a method for displaying an object of interest according to an embodiment.

FIG. 3 shows a user interface that displays tubes related to a pedestrian to be searched.

FIG. 4 shows an example of a user interface according to FIG. 3 implemented in an actual monitoring system.

FIG. 5 is a screen state showing an actually implemented preliminary path.

FIG. 6 shows a user interface that displays a completed path.

FIG. 7 shows an example of displaying a path on a map.

FIG. 8 shows functional blocks of a CCTV monitoring system that implements a method for displaying an object of interest.

### DETAILED DESCRIPTION OF THE INVENTION

Hereinafter, embodiments of the present disclosure will be described in detail with reference to the drawings. However, the detailed descriptions of functions or components that can obscure the gist of the present disclosure in the following descriptions and the accompanying drawings will be omitted. In addition, throughout the specification, when a certain portion “includes” a certain component, it means that the certain portion may further include the other component rather than precluding the other component unless specifically stated to the contrary.

In addition, terms such as “first.” “second,” and the like may be used to describe various components, but the components should not be limited by the terms. The terms may be used to distinguish one component from another component. For example, a first component may be referred to as a second component, and similarly, the second component may also be referred to as the first component without departing from the scope of the present disclosure.

The terms used in the present disclosure are only used to describe specific embodiments and are not intended to limit the present disclosure. The singular includes the plural unless the context clearly dictates otherwise. In the present application, it should be understood that the term “include” or “have” is intended to specify that a feature, a number, a step, an operation, a component, a part, or a combination thereof is present, but does not preclude the possibility of the presence or addition of one or more other features, numbers, steps, operations, components, parts, or combinations thereof in advance.

Unless otherwise defined, all terms including technical and scientific terms used herein have the same meanings as those commonly understood by those skilled in the art to which the present disclosure pertains. The terms defined in a generally used dictionary should be construed as having meanings that coincide with the meanings of the terms from the context of the related technology and are not construed as an ideal or excessively formal meaning unless clearly defined in the present disclosure.

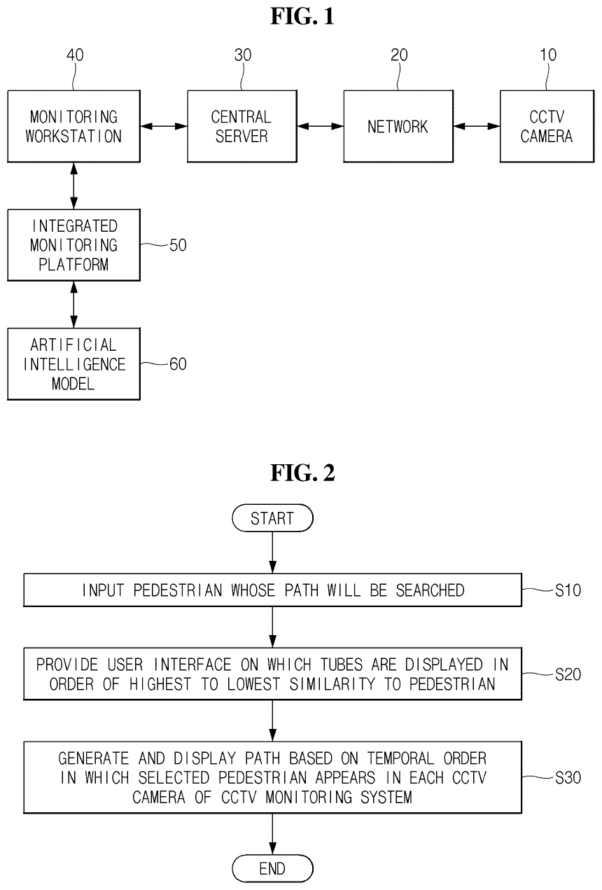

Hereinafter, a method for displaying an object of interest in a CCTV monitoring system according to an embodiment will be described. FIG. 1 is a view showing a configuration of a CCTV monitoring system in which an embodiment is implemented.

In FIG. 1, the CCTV monitoring system may include a CCTV camera 10, a video transmission network 20, a central server 30, a monitoring workstation 40, and an integrated monitoring platform 50.

A plurality of CCTV cameras 10 are installed in public spaces, buildings, etc. The CCTV cameras 10 continuously capture a video of the corresponding area and transmit the captured video in real time to the central server 30. The CCTV cameras 10 may be provided as cameras having high-resolution, night vision, and pan-tilt-zoom (PTZ) functions, etc.

The video transmission network 20 transmits video data from each CCTV to the central server 30 via a wired (e.g., fiber optic or the like) or wireless (4G/5G) network. The video transmission network 20 applies a security protocol to prevent hacking during data transmission.

The central server 30 processes and stores received video data in real time and performs tasks such as video compression, indexing, metadata creation, etc. In addition, the central server 30 may include a high-capacity storage system to enable long-term video storage.

The monitoring workstation 40 is composed of a high-performance computer and large monitors used by monitoring operators and provides a user interface (UI) that may simultaneously display and control a plurality of CCTV videos.

The integrated monitoring platform 50 is a software platform that integrally manages all components of the system and provides functions such as monitoring operator authority management, alarm setting, report generation, and the like, and the integrated monitoring platform 50 includes software for a series of video processing. For example, video management software VMS manages video data received from each CCTV and provides functions such as real-time monitoring, video search, backup, and the like, and the video analysis software performs AI-based analysis functions such as object detection, facial recognition, movement tracking, etc.

In the CCTV monitoring system configured in this way, the CCTV cameras 10 continuously capture videos and transmit the videos to a central server via a network, and the central server 30 processes and stores the received video in real time. At the same time, the VMS manages the videos and generates necessary metadata.

Image analysis software analyzes the video in real time to detect unusual events (e.g., an abnormal behavior, the appearance of specific individuals, or the like), and monitoring operators monitor the real-time video through a monitoring workstation and specifically analyzes a specific video as needed.

When a search for a specific individual is required, the monitoring operator enters search criteria through the integrated monitoring platform and searches for the individual using the video analysis software.

Based on the CCTV monitoring system configured in this way, as shown in FIG. 2, the method for displaying an object of interest of the embodiment includes a first operation S10 of receiving, by a CCTV monitoring system, an object of interest to be searched for, a second operation S20 of acquiring a plurality of tubes related to the object of interest from each camera of the CCTV monitoring system and providing the acquired tubes through the user interface, and a third operation S30 of identifying a search target based on a tube selected through the user interface and generating and displaying a path based on the order in which the identified search target appears in each camera of the CCTV monitoring system, and in the second operation, the plurality of tubes are displayed in order of highest to lowest similarity to the object of interest.

The method for displaying an object of interest of the embodiment may be implemented and installed as software for command execution on the monitoring workstation 40 of the CCTV monitoring system and integrated into the integrated monitoring platform 50.

Hereinafter, each operation will be described in detail. In the following description, the object of interest is set as a pedestrian, but the present disclosure is not limited thereto.

### First Operation S10

In an embodiment, a method for entering a pedestrian whose path will be searched for into a CCTV monitoring system may be implemented as follows.

The system supports an image input module. The image input module may allow a monitoring operator to input an image of the pedestrian to be searched into the system and support the following input methods:
a) File upload: Image files may be uploaded directly from a local storage.
b) Drag and Drop: Images may be dragged and dropped directly onto a user interface.

Alternatively, the system provides a CCTV video selection interface to support the input of a video of the pedestrian to be searched into the system.

Through the CCTV video selection interface, the system provides the monitoring operator with a list of CCTV videos connected to the system and allows the monitoring operator to select a specific CCTV video. The selected video is played, and the monitoring operator may directly specify a pedestrian to be searched within the video.

The CCTV video selection interface may provide a function of allowing the monitoring operator to capture a frame at a desired time point from the CCTV video, and the captured frame is used as the video to be searched for.

In addition, the selection interface may provide a tool for selecting an accurate area of the pedestrian to be searched in the captured frame or uploaded video. This may be implemented as a quadrangular, polygonal, or free-form selection tool.

When the input video is of low quality, the system may apply an algorithm to improve the quality, which includes techniques such as noise removal, sharpening, lighting compensation, etc.

In addition, the system allows inputting multiple videos of the same pedestrian, thereby increasing the accuracy of the search. This enables the system to take into account various angles, lighting conditions, clothing, etc.

In addition, the system may provide an interface for entering textual descriptions of the pedestrian's characteristics in addition to the video, which includes clothing color, height, gender, etc.

In addition, the system may support the input of the last sighting time and position of the pedestrian to be searched. This information may be used to narrow the initial search scope.

When receiving videos or required data from the monitoring operator, the system validates the information entered by the monitoring operator. For example, the system verifies that a video file format is appropriate and all required information has been entered.

The system may provide a screen that allows a monitoring operator to preview all information (videos, metadata, time, position, and the like) entered by the monitoring operator. Accordingly, the monitoring operator may finalize and modify the input information.

Through such a method, the embodiment supports the monitoring operator in various ways to accurately and conveniently enter information on the pedestrian to be searched into the system. This contributes to increasing the accuracy and efficiency of subsequent search and path tracking processes.

### Second Operation S20

Once the pedestrian to be searched is entered by the monitoring operator through the above process, the CCTV monitoring system acquires a plurality of tubes related to the pedestrian to be searched from each camera 10 of the CCTV monitoring system (more accurately, a database of the central server) and provides the plurality of tubes through a user interface. Here, the tube is a basic video clip that allows individual processing of tracked pedestrians within video streams captured from a plurality of CCTV cameras. Accordingly, the system may independently process videos of each camera and focus on a specific tube (i.e., a specific pedestrian) or monitor multiple tubes simultaneously as needed.

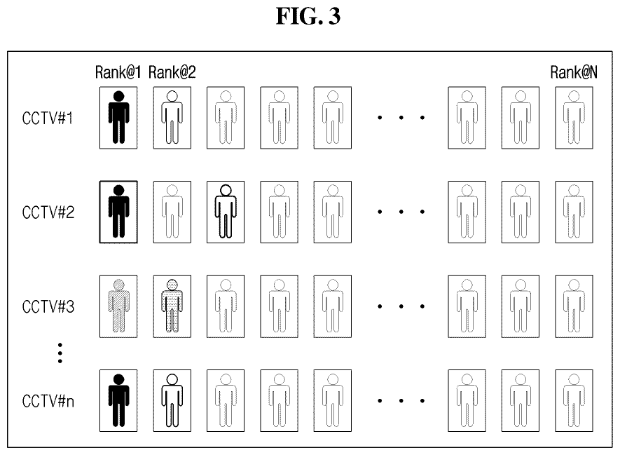

FIG. 3 shows a user interface that displays tubes related to a pedestrian to be searched.

In an embodiment, an operation in which the system searches for candidates and deriving results based on an image (of a pedestrian to be searched) provided by the monitoring operator is as follows.

First, the image received from the monitoring operator is converted into a standardized format through a preprocessing process. In this process, image resizing, color normalization, noise removal, and the like are performed.

Next, the preprocessed image is input to a feature extraction engine and converted into a high-dimensional feature vector. In this case, a deep learning-based feature extractor is used, and for example, a re-identification algorithm may be used, but the present disclosure is not limited thereto. The extracted features may include information such as an appearance, clothing, body type, and the like of a pedestrian.

Subsequently, the extracted feature vector is transferred to an indexing and search engine. This engine searches for pedestrian images with similar features from a pre-built CCTV video database. In the search process, an efficient similarity calculation algorithm is used.

The search results pass through a spatiotemporal consistency verification module. This module verifies the temporal and spatial consistency of the searched candidates and filters impossible movement patterns.

The verified results are sorted by a ranking algorithm. This algorithm determines the ranking of candidates by comprehensively considering similarity scores, spatiotemporal consistency, and other metadata.

The ranked candidates are grouped. This is a process of organizes the results by grouping candidates with similar characteristics.

Finally, the organized results are displayed through a user interface as shown in FIG. 3. In this case, the results are organized into rows, with each row corresponding to a different CCTV, and within each CCTV, they are sorted and displayed in order of highest to lowest similarity.

Through such a technical configuration, in the embodiment, it is possible to efficiently and accurately search for candidates from images provided by the monitoring operator. This process enables rapid and accurate pedestrian identification from large-scale CCTV data and provides the basis for path tracking.

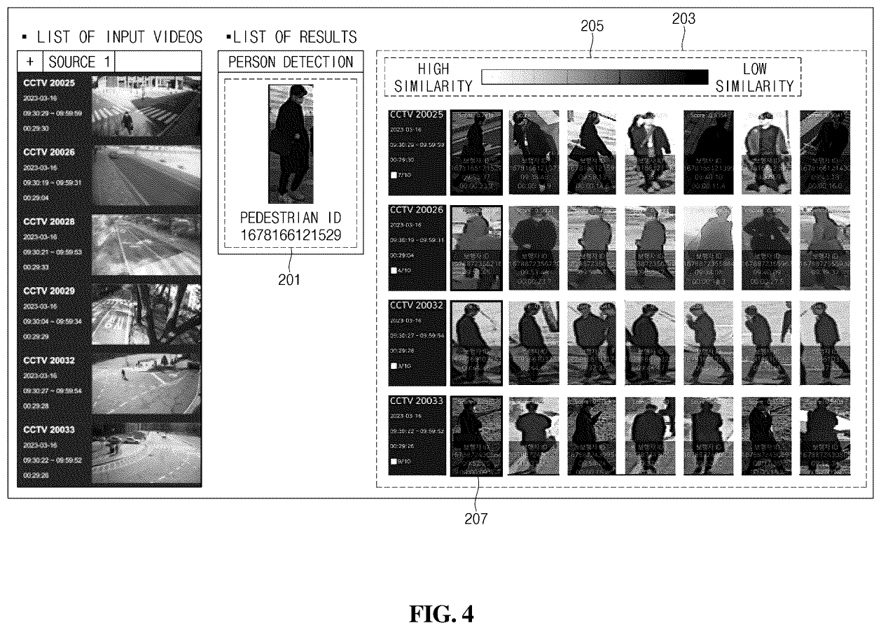

Meanwhile, FIG. 4 shows an example of a user interface according to FIG. 3, which is implemented in an actual monitoring system, and the user interface of the embodiment will be described as follows.

### 1. Input Image Display Area 201:

An initial search target image is fixedly displayed on an upper end of a screen.

When a search target is selected directly from a CCTV or when an image is provided separately from a system, the image is displayed.

### 2. Search Result Display Area 203:

Candidates (displayed in the form of a tube) searched from a plurality of CCTVs are displayed.

The candidates are organized and displayed in rows, with each row corresponding to a different CCTV.

Within each CCTV, the candidates are sorted and displayed in order of highest to lowest similarity. As shown, similarity decreases from left to right.

Colors are used to differentiate between similarities (e.g., redder indicates higher similarity).

The monitoring operator may scroll through the screen to browse the search results.

The monitoring operator may select the person that is determined to be most similar to the input image from the displayed results.

The selected person is visually distinguished and displayed.

### 3. Similarity Display Area 205:

The corresponding area visually displays similarity between the candidates displayed on the input image display area 203 and the initial search target. The user interface of the embodiment includes this area to allow the monitoring operator to intuitively determine similarity.

### 4. Similarity Display Box 205:

The corresponding box indicates similarity between the corresponding tube and a pedestrian to be searched. This box is formed to be color-coded according to similarity. For example, the display box 205 may be displayed in red, with a redder color indicating a higher degree of similarity.

### Third Operation S30

In the third operation, when the monitoring operator selects a path track candidate through the user interface, the system tracks a path of the candidate through a series of data processing and generates and displays the path based on the order in which the target appears in each camera.

This operation will be described in detail as follows.

First, the system sets an initial position and time information of the pedestrian selected by the monitoring operator as a reference point. This information serves as a start point for path formation.

Next, the system searches for video data from CCTVs temporally and spatially adjacent to the initial position. In this case, a search range is set in consideration of an estimated moving speed and direction of the pedestrian.

Next, an algorithm for matching the searched CCTV videos with a pedestrian is applied. This algorithm detects individuals with similar characteristics to the initially specified pedestrian in each CCTV video. For example, this algorithm may use a convolutional neural network (CNN) or Deep CNN (DCNN)-based deep learning model, but the present disclosure is not limited thereto, and various technologies widely known in the relevant field may be used without particular limitations.

Detected similar individuals are sorted in chronological order, and a time interval and spatial distance between detection points are calculated.

Next, the system determines the possibility of movement between the detection points. In this case, a straight-line distance between two points, estimated moving time, actual moving time, and the like are taken into account. Impossible movements (e.g., moving a long distance in too short a time) are filtered.

When the possibility of movement is determined, two factors such as a time interval and a spatial distance may be taken into account.

First, a process of determining the possibility of movement over time will be described as follows.

### [Time Interval]

The system sets an average moving speed of a pedestrian as a reference value. This reference value may be set based on statistical data and typically set to about 4 to 5 km/h.

Next, the system calculates a linear distance and time difference between two consecutive CCTV detection points. Accordingly, the system calculates an actual moving speed in the corresponding section.

Deviation is obtained by calculating a difference between the calculated actual moving speed and a reference speed. This deviation is normalized and represented as a value between −1 and 1.

Depending on the degree of the deviation, the system performs the following processing:

1. When the deviation is within a set threshold value (e.g., +0.2), the system regards movement in the corresponding section as normal and reflects it in a preliminary path.

2. When the deviation exceeds the threshold value in a positive direction (i.e., faster-than-estimated movement), the system performs the following additional analysis on the corresponding section.

a) Checks terrain information of the corresponding section to review whether there are any elements that enable rapid movement, such as ramps, stairs, etc.

b) Re-searches videos of surrounding CCTVs and determines whether any intermediate stop is missed.

c) Compares data with public transportation information to review the possibility that the pedestrian may have taken a bus, a subway, etc.

3. When the deviation exceeds the threshold value in a negative direction (i.e., slower-than-estimated movement), the system performs the following additional analysis.

a) Checks whether there are any places to stay, such as stores, rest areas, within the corresponding section.

b) Closely re-reviews CCTV videos to determine the possibility that a pedestrian may have temporarily stopped or changed direction.

c) Checks weather data to review the possibility of reduced moving speed due to bad weather.

Based on these additional analysis results, the system may generate the path as follows.

1. When the analysis results may reasonably describe a speed difference:

The corresponding information is added as metadata to the movement data and the description of the corresponding section is provided to the monitoring operator.

2. When the analysis results may not describe the speed difference:

The corresponding section is marked as a high-uncertainty section on the user interface and the monitoring operator is requested to verify it manually.

In addition, the system learns these speed difference analysis results, thereby increasing the accuracy of path estimation in similar situations in the future. Through such a process, the present disclosure can provide more accurate and reliable path tracking results by systematically analyzing and processing the difference between the estimated speed and actual required time of the pedestrian.

### [Spatial Distance]

When two or more detection results with identical or very close time information (e.g., within 1 second) are found from different CCTVs, the system performs the following series of analysis and processing processes:

### 1. Precise Time Information Analysis:

The system verifies time synchronization states of each CCTV and verifies whether there are any subtle time differences. Accordingly, the system determines whether it is an actual simultaneous appearance or a result of time discrepancies between CCTVs.

### 2. Position Information Verification:

A physical distance between detected positions is calculated and the minimum time required to move the corresponding distance is calculated. Accordingly, whether a simultaneous appearance is physically impossible is determined.

### 3. Image Re-Analysis:

The corresponding images are re-verified using high-resolution facial recognition and body feature analysis algorithms. This is to minimize errors that may occur during the initial detection process.

### 4. Surrounding CCTV Video Search:

videos from other CCTVs located around the detected simultaneous appearance is searched to collect additional information.

### 5. Past Movement Pattern Analysis:

When previous path information of the corresponding pedestrian is present, the information is analyzed and compared to a current simultaneous appearance situation.

After such an analysis process, the system performs the following determinations and actions:

1. When it is Determined that the Corresponding Situation is a Simple Error:

When it is determined that the corresponding situation is caused by a time synchronization error, an image recognition error, or the like, the erroneous detection results are removed and only the remaining results are considered valid.

2. When it is Determined that the Pedestrian is a Similar Person:

When the re-analysis results indicate that the individuals are different, each is designated as a separate tracking target and the monitoring operator is requested to make a selection.

3. When there is a Possibility of Actual Simultaneous Appearance:

When simultaneous appearance is detected at a position where it is not physically impossible, both paths are marked as possible paths and the determination of the monitoring operator is requested.

### 4. When the Simultaneous Appearance Cannot be Described:

When the simultaneous appearance is confirmed at a physically impossible position, this is marked as an “abnormal situation” and the monitoring operator is immediately notified. This is to review the possibility of system errors, video manipulation, etc.

In all cases, the system logs detailed information on the simultaneous appearance situation, which is used for future system improvement and analysis.

In addition, the system clearly visualizes and presents the simultaneous appearance situation through the user interface, enabling the monitoring operator to easily recognize the situation and make appropriate decisions.

Through such a process, according to the present disclosure, it is possible to significantly improve the accuracy and reliability of pedestrian path tracking by systematically and logically analyzing and processing images that appear at different positions at the same time.

Subsequently, the system connects the remaining detection points to generate a preliminary path. In this process, a shortest path algorithm is applied to generate the most probable movement path.

Once the preliminary path is generated, the system interpolates blind spots between CCTV cameras. This is a process of estimating an estimated path between two consecutive CCTV detection points.

The system performs outlier detection on the interpolated path. When any point deviates significantly from the overall movement pattern, it notifies the monitoring operator and requests a re-review.

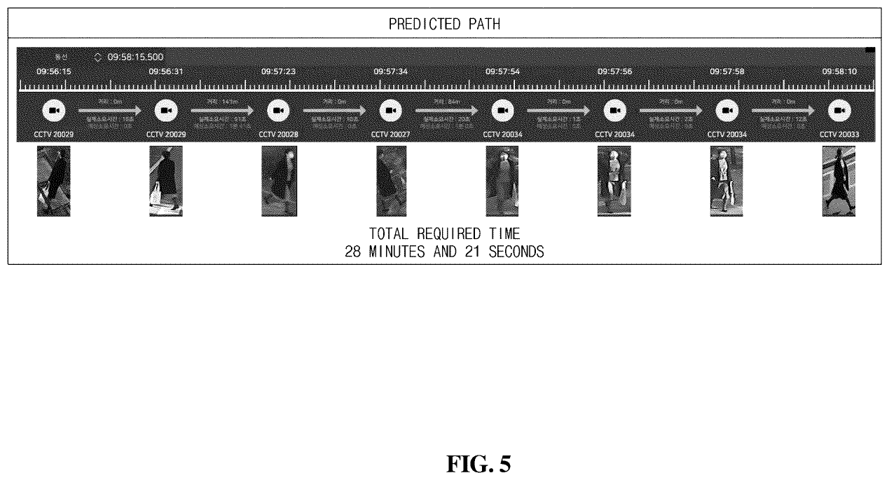

Next, the system visualizes the generated preliminary path and provides the visualized preliminary path to the monitoring operator through a user interface as shown in FIG. 5. In this case, the preliminary path is displayed chronologically, along with CCTV video thumbnails, position information, and time information.

The monitoring operator then reviews the proposed preliminary path and requests a revision as needed. The system re-generates the path based on the modification request of the monitoring operator.

Finally, after the confirmation of the monitoring operator, the system finalizes and saves the final path. The saved path information may be used for future analysis or report generation.

Through this series of processes, according to the present disclosure, a path of a specific pedestrian is automatically generated and is finalized after review and revision by the monitoring operator. This enables efficient and accurate pedestrian path tracking in large-scale CCTV networks.

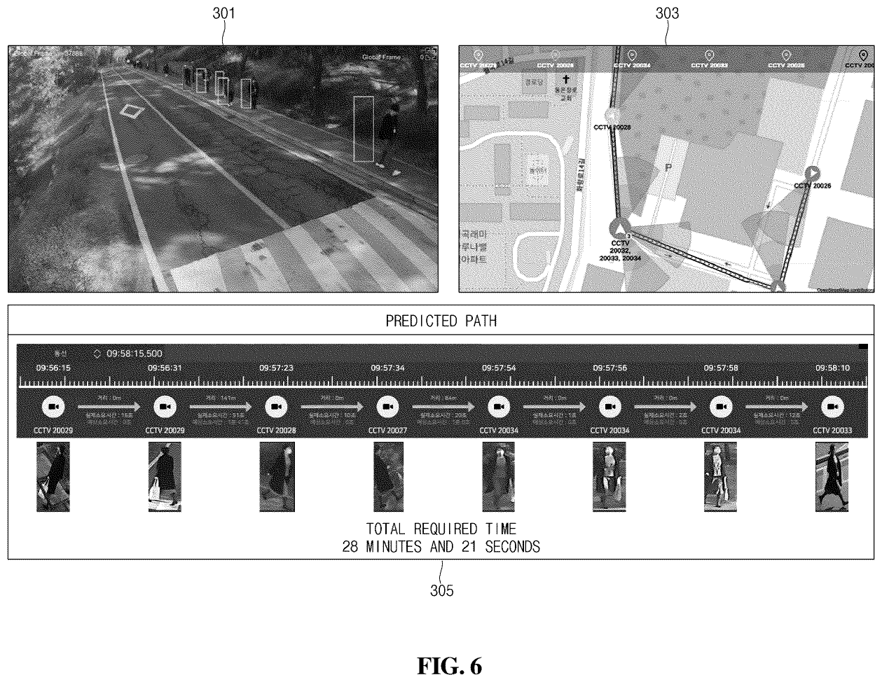

FIG. 6 shows a user interface that displays a completed path.

As shown in FIG. 6, the user interface includes a CCTV area 301 that displays search results from the corresponding CCTV, a map area 303 that displays paths on a map, and an area 305 that displays movement path tracking results along a timeline.

Each area will be described as follows.

### CCTV Area 301:

a) A player capable of playing a CCTV video at a selected time point is displayed.

b) The pedestrian's position within the video is marked by a bounding box.

c) The monitoring operator may perform manipulation such as pausing, rewinding, fast-forwarding the video.

### Map Area 303:

a) The movement path of the pedestrian is marked by a line on the actual map.

b) CCTV detection points are marked by special icons, and hovering the mouse over the corresponding points displays both time information and CCTV numbers.

c) The color of the path line changes in a gradient over time, allowing for intuitive understanding of the direction of movement.

d) A monitoring operator may zoom in and out or pan the map to view a desired area in detail.

### Timeline Area 305:

a) The movement path of the pedestrian is displayed in chronological order.

b) A thumbnail of the pedestrian image captured by the corresponding CCTV is displayed at each point.

c) Both the time information and the CCTV identification number are displayed next to the thumbnail.

d) The estimated path between CCTV detection points is marked by a dotted line.

e) The monitoring operator may scroll up and down the timeline to check the entire movement path.

Meanwhile, when the monitoring operator clicks on a specific point on the timeline provided from the user interface, the corresponding position is highlighted on the map view, and a video at the corresponding time point may be played on the CCTV video view, and also when the monitoring operator clicks on a specific point on the map view, the corresponding time point may be highlighted in timeline, and the relevant CCTV video may be played.

In addition, sections in which it is determined that the system is uncertain may be marked with a special color or pattern on the timeline and map view, and the monitoring operator may be given an option to directly check and modify these sections.

In addition, when multiple possibilities are present, such as detections at different positions at the same time, the system may display all possible paths in different colors on the map to allow the monitoring operator to select the paths.

Meanwhile, the method for displaying a path on a map in the embodiment includes the following two methods.

The first method may connect positions of pedestrians appearing in the CCTV video and display a path. Since this method has been described above in detail, the detailed description thereof will be omitted here.

The second method maps positions of pedestrians detected from the CCTV video onto a 2D map and configures the system to display a current position of the pedestrian in video format.

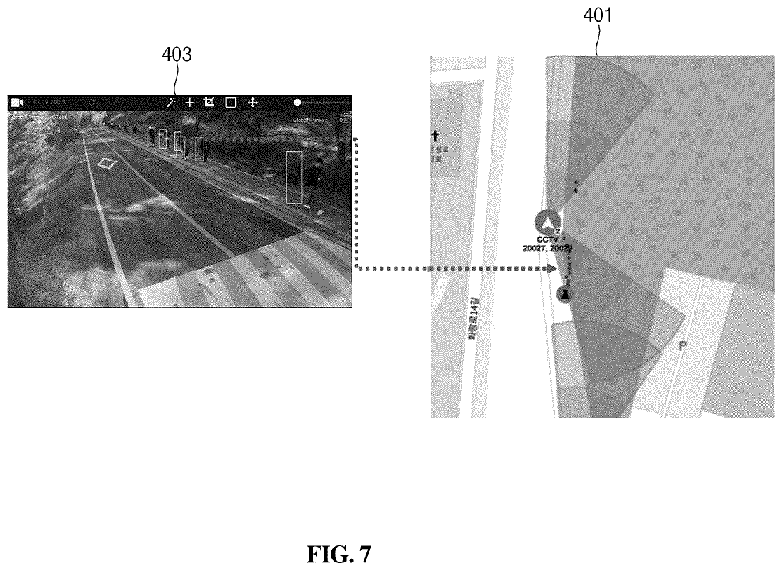

This will be described in detail with reference to FIG. 7 as follows.

First, the system detects pedestrians from a CCTV video. This may be performed using an object detection algorithm, and an area of the detected pedestrian may be marked by a bounding box.

Next, 2D coordinates of the detected pedestrian patch are converted into 2D coordinates on an actual map. In this process, a method of using a homography matrix between the video and the map or calculating 3D coordinates of the pedestrian bounding box through depth estimation of the video, and then projecting it onto 2D map coordinates is used.

The converted coordinates are updated in real time and displayed on a 2D map 401. In this case, a current position of the pedestrian is represented by a specific icon or marker, and previous positions are linked to generate a movement path.

The system repeats this process for each CCTV frame and continuously updates the pedestrian's position. Accordingly, the real-time movement of the pedestrian may be tracked on the 2D map.

In addition, when the monitoring operator selects an icon on the 2D map 401, the system reads a tube corresponding to the corresponding position and displays a CCTV video through a window 403.

In addition, when the same pedestrian is detected simultaneously on multiple CCTVs, the system determines the final position through a weighted average in consideration of the accuracy and field of view of each CCTV. This contributes to increasing the accuracy of the position estimation.

In addition, in order to account for cases in which the pedestrian temporarily moves out of the field of view of the CCTV, the system may continuously update the estimated position by applying a prediction algorithm based on the previous movement patterns of the pedestrian.

In addition, in order to represent the temporal information of the movement path, the system may change the color or thickness of a path line over time. Accordingly, the monitoring operator may intuitively identify the movement order and speed of the pedestrian.

In addition, in order to indicate the uncertainty of the position estimation, the system may display a circular error range at each position point. The size of this error range is dynamically adjusted based on the reliability of the estimation.

Through such a method, according to the present disclosure, by mapping the position of the pedestrian detected from the CCTV video to the 2D map and continuously updating and displaying the position, more precise and dynamic movement tracking results can be provided. This enables effective visualization and analysis of pedestrian movements in complex environments, thereby significantly improving the performance of the CCTV monitoring system.

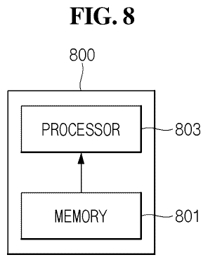

FIG. 8 shows functional blocks of a CCTV monitoring system that implements the method for displaying an object of interest. The method is implemented and installed in the CCTV monitoring system as a program for command execution, and when reconfigured as functional blocks, a CCTV monitoring system 800 may include a memory 801 for storing the program and at least one processor 803 configured to execute commands defined in the program, and the commands are programed as computer-readable codes that implement the method for displaying an object of interest.

For example, the command includes a first operation of receiving an object of interest to be searched, a second operation of acquiring a plurality of tubes related to the object of interest from each camera of the CCTV monitoring system and providing the acquired tubes through a first user interface, a third operation of identifying the search target based on the tubes selected through the user interface and generating and displaying a path based on the order in which the identified search target appears in each camera of the CCTV monitoring system, and in the second operation, the plurality of tubes are displayed in order of highest to lowest similarity to the object of interest.

Meanwhile, the method for displaying an object of interest of the present disclosure may be implemented as computer-readable code on a computer-readable recording medium. The computer-readable recording media include all types of recording devices that store data readable by a computer system.

Examples of the computer-readable recording media include a ROM, a RAM, a CD-ROM, a magnetic tape, a floppy disk, optical data storage devices, etc. In addition, the computer-readable recording media may be distributed across a network-connected computer system to allow the computer-readable code to be stored and executed in a distributed manner. In addition, functional programs, codes, and code segments for implementing the present disclosure can be easily inferred by programmers in the art to which the present disclosure pertains.

The present disclosure has been described above with reference to various embodiments thereof. Those skilled in the art to which the present disclosure pertains will understand that the present disclosure may be implemented in a modified form without departing from the essential characteristics of the present disclosure. Accordingly, the disclosed embodiments should be considered in an illustrative rather than a limiting sense. The scope of the present disclosure is described in the claims rather than the above description, and all differences in the equivalent scope should be construed as being included in the present disclosure.

What is claimed is:

1. A method for displaying an object of interest in a CCTV monitoring system, the method comprising:
a first operation of receiving, by the CCTV monitoring system, an object of interest to be searched;
a second operation of acquiring, by the CCTV monitoring system, a plurality of tubes related to the object of interest from each camera of the CCTV monitoring system and providing the tubes through a first user interface; and
a third operation of identifying, by the CCTV monitoring system, a search target based on a tube selected through the first user interface and generating and displaying a path based on the order in which the identified search target appears in each camera of the CCTV monitoring system,
wherein the tube is a basic video clip that allows individual processing of a tracked object of interest within video streams received from a CCTV camera, and
in the second operation, the plurality of tubes are displayed in order of highest to lowest similarity to the object of interest.

2. The method of claim 1, wherein, in the first operation, characteristics of the object of interest to be searched are received as text, or a time and position of the last sighting of the object of interest are further received.

3. The method of claim 1, wherein, in the second operation, the plurality of tubes are classified and displayed by CCTV.

4. The method of claim 3, wherein the first user interface includes an area that displays the object of interest to be searched, an area that displays tubes searched from a plurality of CCTVs, and an area that displays similarity between the object of interest to be searched and the searched tube.

5. The method of claim 3, wherein the first user interface further includes a similarity display box that is color-coded according to the similarity between the corresponding tube and the object of interest to be searched.

6. The method of claim 1, wherein the third operation includes:
an operation (a) of searching for a search target in adjacent CCTVs based on an initial position of the identified search target in consideration of an estimated moving speed and direction of the search target;
an operation (b) of sorting the searched search targets in chronological order,
an operation (c) of determining whether the search target is likely to move between detection points of the search target based on a time interval and spatial distance between the detection points; and
an operation (d) of connecting the detection points based on the determination to generate a preliminary path.

7. The method of claim 6, wherein the preliminary path is displayed in chronological order along with at least one of a CCTV video thumbnail, position information, and time information.

8. The method of claim 6, wherein, when the path is confirmed by selection of a monitoring operator after the operation (d), the third operation includes configuring and displaying a second user interface including a CCTV area that displays search results from the corresponding CCTV, a map area that displays the path on a map, and an area that displays path tracking results along a timeline.

9. The method of claim 8, wherein, in the second user interface, a section that it is determined that the CCTV monitoring system is uncertain is distinguished and displayed with a special color or pattern in the timeline and map view.

10. The method of claim 8, wherein, in the map area, a path is displayed by connecting positions according to CCTVs in which the search target appears.

11. The method of claim 8, wherein, in the map area, the position of the search target is mapped to a 2D map and displayed as an icon on the 2D map, and when the icon is selected, a CCTV video at the corresponding position is displayed.

12. A CCTV monitoring system comprising:
a memory configured to store a program; and
at least one processor configured to execute commands defined in the program,
wherein the commands are programed as computer-readable codes that implement the method for displaying an object of interest of claim 1.

13. A recording medium having recorded a program coded to be read by a computer to implement the method for displaying an object of interest of claim 1.
